(19) United States
(12) Patent Application Publication
(10) Pub. No.: US 2004/0015434 A1
(43) Pub. Date: Jan. 22, 2004

(54) Real estate decision support system

(75) Inventors: John J. McCue, Uxbridge, MA (US); Richard L. Pace, Rehoboth, MA (US)

Correspondence Address: Edwards & Angell, LLP, 101 Federal Street, Boston, MA, 02110, US

(73) Assignee: UDM Land Sciences, Inc., Providence, RI

(21) Appl. No.: 10/364,304

(22) Filed: Feb. 10, 2003

Related U.S. Application Data
(60) Provisional application No. 60/356,853, filed on Feb. 13, 2002.

(51) Int. Cl. G06F 17/60

(52) U.S. Cl. 705/38; 705/26

(57) ABSTRACT

A method of providing a structured framework to assist land use professionals and others in evaluating information about real estate is disclosed. A geographic information system (GIS) with access to private and public databases of real estate information is combined with software providing structure to real estate decision making processes. Additionally, access is provided to individuals which are experienced in the particular type of analysis being performed. The experienced individuals are able to assist throughout the evaluation process if desired by the user. After a user chooses parameters for a request, the software interacts with the geographic information system (GIS) to retrieve the appropriate data. The software also provides access to additional relevant information if so desired by the user. By automating the frame work around the GIS, the land use professional or other individuals requesting real estate information have a greater likelihood of considering all the relevant information available for the particular decision making process being executed.

### RELATED INFORMATION

This application claims priority to U.S. provisional Application No. 60/356,853, entitled “REAL ESTATE DECISION SUPPORT SYSTEM,” filed on Feb. 13, 2002.

### FIELD OF THE INVENTION

The illustrative embodiment of the present invention relates generally to a real estate decision support system, and more particularly to a network based geographic information, data management and analysis system encompassing real estate data, including environmental data pertinent to real estate transactions.

### BACKGROUND

Land use professionals and others are often required to evaluate various pieces of real estate. Frequently, the evaluation is performed to determine whether an activity is an acceptable use of a particular piece of land or to evaluate real estate for acquisition purposes. The evaluation process requires the land use professional to gather and analyze large amounts of data from disparate sources. The data includes information such as taxes, details about structures on the real estate being evaluated, geographic location, climate data, and information about the surrounding neighborhood. The information being evaluated may also include environmental information such as the location of wetlands and pollution sites. Unfortunately, the information retrieval process is difficult because the various sources of information required for the evaluation process are scattered among multiple locations.

A Geographic Information System (GIS) is a computer system which is used to assemble, store, manipulate and display geographically referenced information, such as data identified according to location (i.e.: an object located at 36° longitude, 122° latitude). GIS technology may be used for a variety of purposes, including scientific investigations, resource management, and development planning. A GIS may be used to model emergency response times or develop plans for wetland protection. A GIS stores data as layers of information so as to make complex analysis of the data possible. GIS systems work by associating the source data with location variables. The location may be specified as x, y and z coordinates of longitude, latitude, and elevation, or by systems such as zip codes or highway mile designations. Public and private databases exist which may be entered directly into a GIS. Public databases are often produced by federal agencies while private databases are compiled and maintained by various private companies. Unfortunately, conventional GIS systems are designed to compile data from multiple sources into a single presentation without accommodating analysis and knowledge making tools which account for the overall objective of the requesting party, such as the analysis of a prospective land acquisition.

### SUMMARY OF THE INVENTION

The illustrative embodiment of the present invention provides a GIS, data management and analysis technology specifically designed for the land use professional and others evaluating real estate information. The GIS gathers information from multiple sources that are of interest to the land use professional. A software framework is created so that the information gathered by the GIS is presented in a structured decision framework. The manner of presentation of the data is driven by the particular process being engaged in by the land use professional. The real estate GIS and accompanying software framework acts as an aid in the decision making process by increasing the likelihood that all relevant data is analyzed and compared. Experienced professionals are made available to the user to render assistance throughout the process.

### BRIEF DESCRIPTION OF THE DRAWINGS

FIG. 1 is a block diagram of an environment suitable for practicing the illustrative embodiment of the present invention;

FIG. 2 is a flow chart of the sequence of steps followed by the illustrative embodiment of the present invention in generating maps for a user;

FIG. 3 is a map generated by the illustrative embodiment of the present invention in response to a user request;

FIG. 4 is a map and associated report generated by the illustrative embodiment of the present invention; and

FIG. 5 is a flow chart of the sequence of steps followed by the illustrative embodiment of the present invention utilizing the software decision framework and experienced professionals.

### DETAILED DESCRIPTION

The illustrative embodiment of the present invention provides a structured framework to assist land use professionals and others in evaluating information about real estate. A geographic information system (GIS) with access to private and public databases of real estate information and the following features:

Ellipsoidal model of the Earth
Database querying using SQL
2D Uniform, category, and range rendering
Visualization

3D Graphics

Computational geometry

Buffer zones
boolean operations on lines and polygons

AND,OR,NOT,XOR

Elevation models

triangulation
viewsheds
watersheds
contouring

Spatial queries
Image Processing

Enhancement - all with Area of Interest

Brightness/Contrast/Gamma
Threshold
Histogram
LUT
Pseudocolor
Convolution
Spatial Filters
Frequency Spectra
Image Blending
Wavelet Transforms

Feature Extraction

Edge Detection
Feature Classification
Vectorizing

Registration/Rectification

is combined with software providing structured analysis to real estate decision making processes. Additionally, access is provided to individuals which are experienced in the particular type of analysis being performed. The experienced individuals are able to assist throughout the evaluation process if desired by the user. After a user chooses parameters for a request, the software interacts with the geographic information system (GIS) to retrieve and analyze the appropriate data. The software also provides access to additional relevant information if so desired by the user. By automating the framework around the GIS, the land use professional or other individuals requesting real estate information have a greater likelihood of considering all the relevant information available.

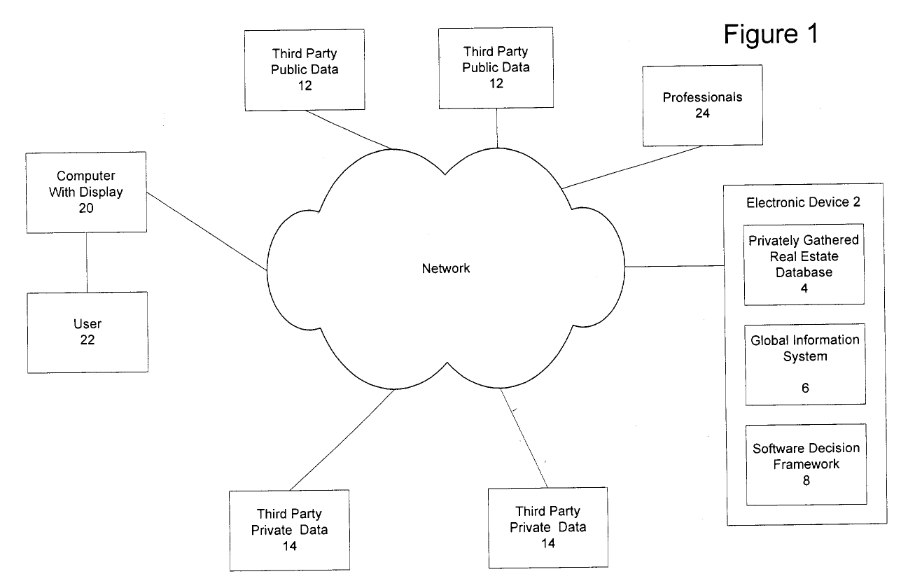

FIG. 1 depicts a block diagram of an environment suitable for practicing the illustrative embodiment of the present invention. An electronic device 2 includes a storage location for a privately gathered real estate database 4. The privately gathered real estate database 4 may be any one of a number of different types of databases. In one embodiment the privately gathered real estate database 4 is a Microsoft SQL database. The privately gathered database 4 holds real estate related information and may include data not otherwise available such as local soil compositions based on samples. Those skilled in the art will recognize that the privately gathered database 4 may alternately be located remotely from the electronic device 2. Also included on the electronic device 2 are a GIS 6 and a software decision framework 8. The software decision framework 8 interacts with the GIS 6 to control the flow of information to a requesting user. The electronic device 2 is interfaced with a network 10. The network may be a local area network (LAN), a wide area network (WAN), an intranet, the Internet, a wireless network, a satellite network, or another type of network. Also interfaced with the network 10 are multiple storage locations for public databases 12 holding data relevant to real estate, such as local water billing rates or earthquake likelihood from a U.S. Geological Survey (Dept. of the Interior), as well as multiple storage locations for third party private databases 14. The private third party databases may be available to the public on a subscription basis or via some other limited access manner. The network 10 is also interfaced with a computer with a display 20 and a user 22. Those skilled in the art will recognize that other types of electronic devices capable of accessing the network 10 may be substituted for the computer with display 20 without departing from the scope of the present invention. The user 22 may submit requests across the network 10 to the electronic device 2. Professionals 24 experienced in various types of real estate evaluations are also interfaced with the network 10. The professionals 24 may be land use planners, developers, ecologists, real estate agents or others with knowledge particularly relevant to the type of real estate evaluation being performed. The software decision framework 8 provides access to the professionals 24 by the user 22 upon request.

The illustrative embodiment of the present invention provides a software decision control framework 8 which interacts with the GIS 8 in presenting data to the user 22. In certain types of processes involving the evaluation of real estate information, the user 22 will almost always be concerned with particular types of information. For example, in a residential real estate transaction, a prospective purchaser will almost always be concerned with schools in the surrounding community. A developer will almost always be concerned about the presence of wetlands on, or adjacent to, potential development sites. The software decision control framework 8 provides access to information likely to be of interest to a user 22 based on the overall objective behind the user's query to the GIS 6. For example, for a prospective residential real estate purchaser who requests a map of a particular piece of property, the software decision control framework may provide a pop up dialog box or similar means inquiring if the prospective purchaser is interested in additional school information over and above that presented on the initial map. Alternatively, the map generated may contain a link that when clicked on with a mouse will generate a table of school information. The additional information provided by the software decision framework 8 is context sensitive, a developer seeking wetland information would likely not be presented with school information options. The software decision framework 8 provides an additional interface between the user 22 and the GIS 6. In one embodiment, the interface is written in Visual Basic, but other languages may be used without departing from the scope of the present invention.

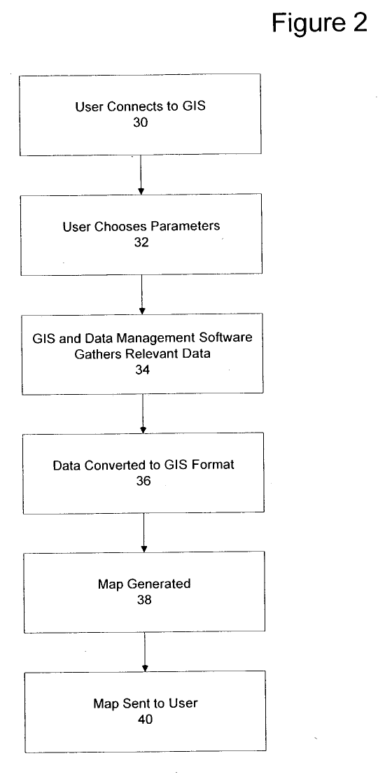

FIG. 2 is a flow chart of the sequence of steps followed by the illustrative embodiment of the present invention in responding to a user request for real estate information. The sequence begins when a user 22 connects to the GIS 6 over the network (step 30). The user selects a type of real estate search and indicates parameters for the search (step 32). The GIS 6 and data management software retrieves the relevant real estate data from the public and private databases (step 34). The data is converted to GIS format (step 36) and a map (or other chosen type of format such as tables, lists, 3D visual models, etc., is generated) (step 38). The map is then sent to the user 22 (step 40).

The illustrative embodiment of the present invention allows a land use professional to enter simple geographic and environmental conditions in order to generate a series of complex data reviews and correspondences while being guided through a decision making protocol. The material available to the GIS involves a mix of both private and public data, The public data includes databases created and maintained by various public agencies. The private data may similarly involve databases maintained by private organizations and/or individuals. The private data may or may not be directly affiliated with the operator of the GIS. The data may include information regarding environmental conditions such as the soil composition in a particular area, the amount of rainfall for a particular area, the nearby presence or absence of toxic waste sites, the ability of an area to support freshwater wells, and other similar real estate information.

The third party public data and third party private data may be stored in a number of different formats which the illustrative embodiment of the present invention must translate prior to using the data. For example, the third party data may be stored as state plane coordinates. The State Plane Coordinate System (SPCS) is used in the United States and divides each state into a number of zones(the number of zones varies with each state from one zone to as many as five zones). Each zone has a grid system overlayed on the zone and particular sites within the zones are located with reference to the grid points. The unit of measurement is usually expressed in feet although metric measurements may also be used. The illustrative embodiment of the present invention translates the state plane coordinates into GIS protocol coordinates (featuring longitude and latitude coordinates). Once the data has been converted into the GIS format, the data is stored in a database, such as a Microsoft SQL database. The data is stored in layers with separate tables tracking what layers should be used to generate which type of maps (or other form of display). Attributes associated with geographic data may be stored in separate cross-referenced layers. Upon receiving a request for a type of map, a map table is consulted, data is retrieved from the appropriate layer(s), and the map is generated and presented to a requesting user. The cross-referenced layers of non-geographic coordinate attributes may be used to quickly generate additional information by the software decision framework 8, either as part of the initial display or as part of a subsequent display of information directly requested by the user.

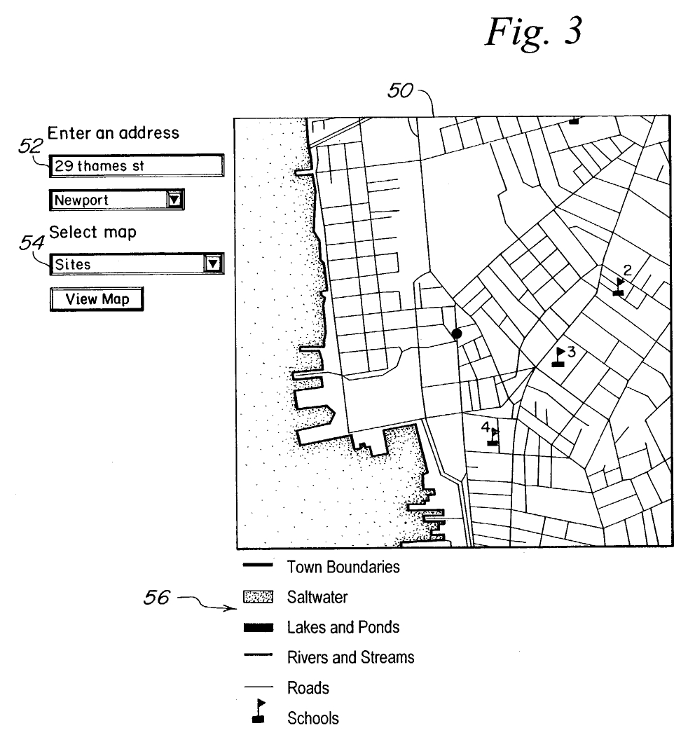

FIG. 3 depicts a map 50 generated by the illustrative embodiment of the present invention. A user 22 enters a property address into a dialog box 52 and selects the type of map in the map selection box 54. The map includes a legend of map designations 56 such as town boundaries, salt water areas, lakes and ponds, rivers and streams, roads, and schools. The real estate information may be presented in multiple alternate formats without departing from the scope of the illustrative embodiment of the present invention.

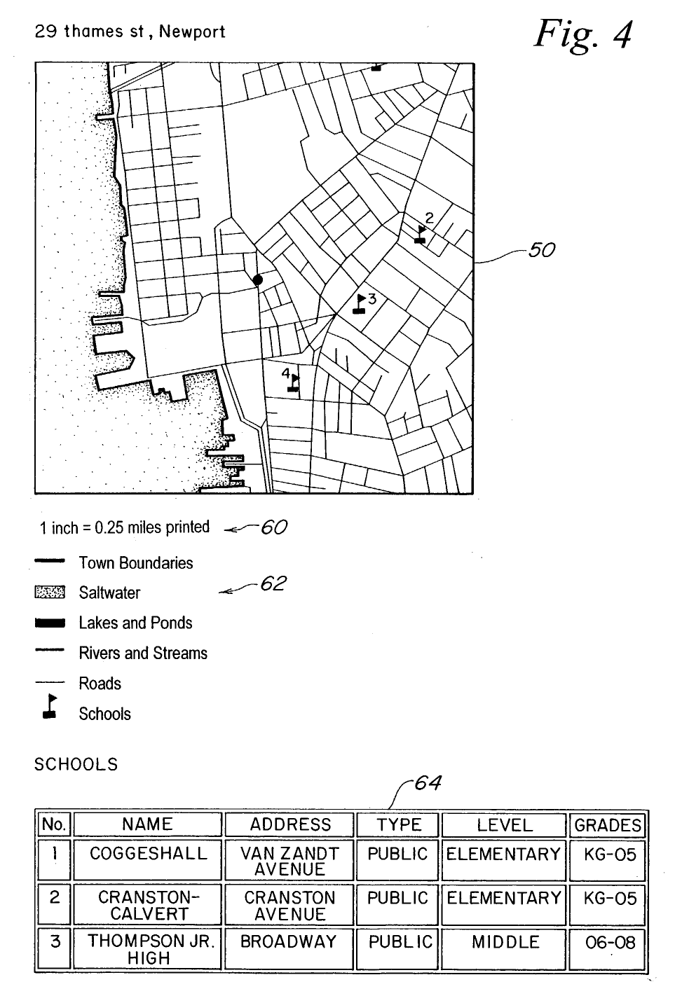

FIG. 4 depicts the map 50 of FIG. 3 which is presented alongside additional information relevant to the map. The map includes a scale 60 and a legend of map designations 62. Also included is additional information in the form of a report chart 64 referencing schools appearing on the map 50. Information regarding the origin of the data used to generate the map is also available to the user 22. For example, the information about the origin of the data used to generate the school map may include the GIS data layer from which the information was retrieved, may indicate whether or not the various schools are public schools, private schools or a mixture. The information about the origin of the data may identify the method in which the school locations were initially identified, i.e., from aerial photography or telephone calls to schools throughout the area. The age of the school information may be indicated as may be the scale and the GIS protocol being followed. Additional related GIS data layers may be indicated, as well as the positional accuracy of objects and references appearing on the map.

Since automated processes are unable to anticipate every possible inquiry from a user no matter how repetitive the type of real estate analysis being performed, the illustrative embodiment of the present invention provides access to professionals experienced in the type of evaluation being performed. In one embodiment, the access may be provided on a fee basis (i.e.: a higher payment is required to consult the live professionals) than the use of automated portion of the illustrative embodiment. Access may be made available in a number of ways, by having the professionals on call, by means of a follow up communication (i.e.: telephone call, email, fax), or by scheduling a future meeting. By adding a human element to the process, the illustrative embodiment of the present invention helps to ensure a greater consideration of relevant factors during the process of the real estate evaluation.

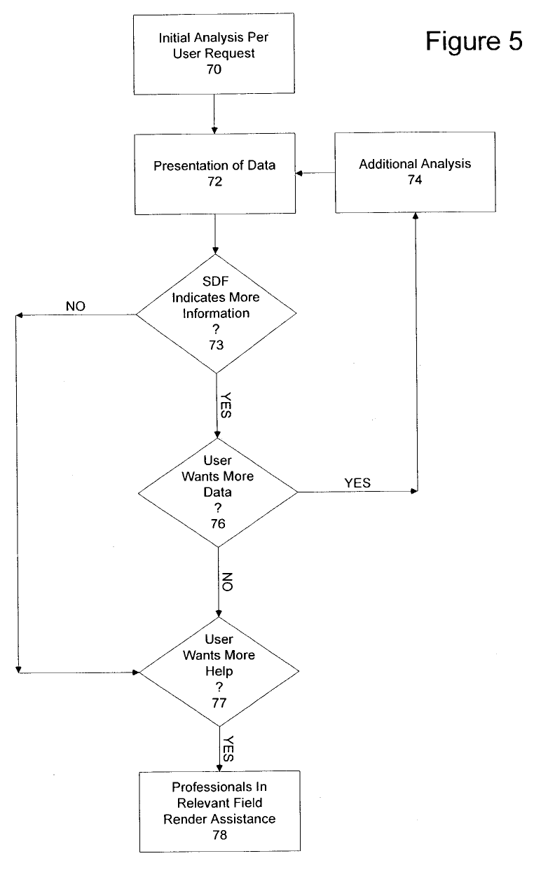

The use of the software decision framework 8 and the access to human professionals is shown in the sequence of steps depicted in FIG. 5. The process begins with the initial analysis of real estate related data performed pursuant to user request as outlined above (step 70). The analyzed data is presented to the requesting user (step 72). The software decision framework 8 suggests the availability of additional related information based on the overall objective of the user's search if such information is available(step 73). If the software decision framework suggests the availability of additional information (step 73), the user then either indicates a desire for additional information or indicates no additional information is desired (step 75). If the user indicates additional information is desired, an additional analysis is performed by the GIS 6 on the related data (step 74) and the data is presented to the user (step 72). The process then iterates with the software decision framework 8 suggesting additional information if it is available (step 73). If the additional information is not available (step 73) or the user indicates that it does not desire additional data (step 75), the user is presented with the opportunity to consult with experienced human professionals (step 77). If the user indicates that more help is desired, assistance is rendered by human professionals experienced in the current type of evaluation process (step 78). Those skilled in the art will recognize that access to the skilled professionals may be provided at other times throughout the evaluation process without departing from the scope of the current invention.

It will thus be seen that the invention attains the objectives stated in the previous description. Since certain changes may be made without departing from the scope of the present invention, it is intended that all matter contained in the above description or shown in the accompanying drawings be interpreted as illustrative and not in a literal sense. Practitioners of the art will realize that the sequence of steps depicted in the figures may be altered without departing from the scope of the present invention and that the illustrations contained herein are singular examples of a multitude of possible depictions of the present invention.

We claim:

1. In a computer network interfaced with at least one storage location holding publicly maintained data relating to real estate and at least one storage location holding privately maintained data relating to real estate, a method, comprising the steps of:
providing a Global Information System (GIS), said GIS being capable of translating said publicly maintained data and said privately maintained data into a common format;
providing a programmatic decision protocol for real estate evaluation, said protocol generating queries directed to said GIS, said queries embodying an objective for said real estate evaluation and including parameters;
receiving a query with said GIS regarding said real estate;
programmatically retrieving data relating to said real estate from said publicly maintained data and said privately maintained data based on said parameters in said query.

2. The method of claim 1, comprising the further step of:
displaying said data to a user who requested the real estate evaluation.

3. The method of claim 1, comprising the further steps of:
providing access to professionals experienced in evaluating said real estate data.

4. The method of claim 1 wherein at least one of said publicly maintained data and said privately maintained data includes information about environmental conditions relating to said real estate.

5. The method of claim 4 wherein said environmental condition data includes at least one of soil composition data, wetland location data and toxic waste site location data.

6. The method of claim 1. wherein at least one of said publicly maintained data and said privately maintained data includes information about schools in the vicinity of said real estate.

7. The method of claim 1 wherein a distance parameter included in said query controls the amount of data retrieved, said distance parameter establishing a radius beginning at the location of said real estate and extending the length of said distance parameter, the retrieved data relating to locations within said radius.

8. In a computer network interfaced with at least one storage location holding publicly maintained data relating to real estate and at least one storage location holding privately maintained data relating to real estate, a method, comprising the steps of:
providing a computer-implemented decision protocol for real estate evaluation, said protocol generating a query designed to retrieve selected portions of said publicly maintained data and said privately maintained data, said query embodying an objective for said real estate decision evaluation and including parameters;
translating programmatically said publicly maintained data and said privately maintained data into a common format; and
using said query to retrieve data relating to said real estate from said publicly maintained data and said privately maintained data.

9. The method of claim 8, comprising the further steps of:
displaying the retrieved data to a user who requested the real estate evaluation.

10. The method of claim 9, comprising the further steps of:
generating a new query in response to an indication from said user; and
retrieving additional information from at least one of said publicly maintained data and said privately maintained data in response to said new query.

11. The method of claim 8 wherein at least one of said publicly maintained data and said privately maintained data includes information about environmental conditions relating to said real estate.

12. The method of claim 11 wherein said environmental conditions data includes at least one of soil composition data, wetland location data and toxic waste site location data.

13. The method of claim 8 wherein at least one of said publicly maintained data and said privately maintained data includes information about schools in the vicinity of said real estate.

14. The method of claim 8, comprising the further steps of:
providing access to professionals experienced in evaluating said real estate data.

15. The method of claim 14 wherein said access to said professionals is provided contemporaneously with the retrieval of said data.

16. In a computer network interfaced with at least one storage location holding publicly maintained data relating to real estate and at least one storage location holding privately maintained data relating to real estate, a medium holding computer-executable steps for a method, said method comprising the steps of:
providing a Global Information System (GIS), said GIS being capable of translating said publicly maintained data and said privately maintained data into a common format;
providing a programmatic decision protocol for real estate evaluation, said protocol generating queries directed to said GIS, said queries embodying an objective for said real estate evaluation and including parameters;
receiving a query with said GIS regarding said real estate;
programmatically retrieving data relating to said real estate from said publicly maintained data and said privately maintained data based on said parameters in said query.

17. The medium of claim 16 wherein the retrieved data is displayed to a user who requested the real estate evaluation.

18. The medium of claim 17, wherein said method comprises the further steps of:
generating a new query in response to an indication from said user; and
retrieving additional information from at least one of said publicly maintained data and said privately maintained data in response to said new query.

19. The medium of claim 16 wherein at least one of said publicly maintained data and said privately maintained data includes information about environmental conditions relating to said real estate.

20. The medium of claim 16 wherein said environmental condition data includes at least one of soil composition data, wetland locations data and toxic waste site location data.
